(19) United States
(12) Patent Application Publication
(10) Pub. No.: US 2009/0095021 A1
(43) Pub. Date: Apr. 16, 2009

(54) HYDROPHOBIC GLASS SURFACE

(75) Inventor: Markku Rajala, Vantaa (FI)

Correspondence Address: OLIFF & BERRIDGE, PLC, P.O. BOX 320850, ALEXANDRIA, VA, 22320-4850, US

(73) Assignee: BENEQ OY, Vantaa (FI)

(21) Appl. No.: 12/294,101

(22) PCT Filed: Mar. 26, 2007
(86) PCT No.: PCT/FI07/50162

§ 371 Date: Oct. 6, 2008

(30) Foreign Application Priority Data
Mar. 27, 2006 (FI) 20060287

(51) Int. Cl. C03C 17/02; C03C 17/00

(52) U.S. Cl. 65/60.5; 65/60.1; 977/773

(57) ABSTRACT

The invention relates to a method of forming a hydrophobic surface for glass or glazing. The method comprises producing particles having an average aerodynamic particle size of less than 200 nm and guiding the particles further onto the glass surface. The particles to be produced according to the invention are hydrophobic particles and the particles are guided onto the glass surface so that they at least partly dissolve and/or diffuse into the glass surface.

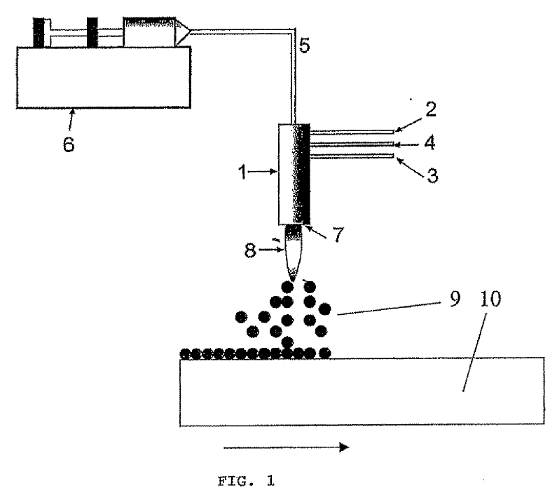

### BACKGROUND OF THE INVENTION

The invention relates to a method of producing a hydrophobic glass surface during glass production or processing. In particular, the invention relates to a method according to the preamble of claim 1 for forming a hydrophobic surface for glass or glazing, the method comprising producing particles having an average aerodynamic particle size of less than 200 nm and guiding the particles further onto the glass surface.

A hydrophobic, i.e. water repellent, surface is advantageous in several applications, such as car windscreens and self-cleaning and/or easy-to-clean glass surfaces. The hydrophobic surface is based on the well-known lotus phenomenon. Glass surfaces based on the phenomenon are described, for example, in Martin Bauman et al., “Learning from the Lotus Flower-Selfcleaning Coatings on Glass”, Glass Processing Days 2003 proceedings, pp. 330-333, Tampere, Finland. The lotus phenomenon is based on a surface where the surface material has a relatively high hydrophobicity, i.e. the contact angle is larger than 100°, and the surface is also provided with a nano/micro structure which increases the real contact angle significantly, i.e. to an angle larger than 150°. Such surface becomes highly water repellent, i.e. super hydrophobic. The influence of the surface structure on hydrophobicity is dealt with, for example, in J. Kim & C. J. Kim, “Nanostructure Surfaces for Dramatic Reduction of Flow Resistance in Droplet-Based Microfluids”, The Fifteenth IEEE International Conference on Micro Electro Mechanical Systems, 2002, pp. 479-482, Las Vegas, Nev., USA.

U.S. Pat. No. 5,800,918 describes a window glass consisting of a glass substrate and of a one-layered or mini-layered coating which at least partly covers the substrate, is hydrophobic or oleophobic and has a base layer as the bottom layer. Fluorinated alkyl silanes are used in the production of the hydrophobic layer. The method is complicated and even though it provides a significant improvement over other techniques against wear caused by windscreen wipers, its wear resistance is still relatively poor (approximately 100 operating hours of windscreen wipers).

Wu, Y. et al., “Thin films with nanotextures for transparent and ultra water-repellent coatings produced from trimethylmethoxysilane by microwave plasma CVD”, Chem. Vap. Deposition, March 2002, vol. 8, no. 2, pp. 47-50 discloses production of a hydrophobic nano-structured surface by a plasma-assisted chemical vapour phase process.

Skandan G., et al., “Low-pressure flame deposition of nanostructured oxide films”, J. Amer. Cer. Soc, October 1998, vol. 81, no. 10, pp. 2753-6 discloses a method of producing nanoparticles in flame for coating a substrate by the nanoparticles thus produced.

PCT application WO 2005/115531 A2 discloses production of magnetic nanoparticles and the use of the particles in coating medical instruments.

In the prior art methods, the glass is rendered hydrophobic by silane treatment or by treating the glass surface with a teflon-containing wax or the like.

The micro/nanostructure necessary for achieving super hydrophobicity is achieved according to prior art by chemical vapour phase growth (CVD), physical vapour phase growth (PVD), lithographic method, microprinting, etching or by a self-organizing nanostructure.

A problem associated with all the methods is the poor mechanical durability of the resulting hydrophobic coating, which becomes apparent, in particular, as disappearance of hydrophobicity in the use of windscreen wipers. Also in several other applications, the hydrophobic coating provided on the glass wears out and comes off, in which case the surface loses its hydrophobicity.

### BRIEF DESCRIPTION OF THE INVENTION

The object of the present invention is to eliminate the above-mentioned drawbacks and to provide a hydrophobic glass surface that solves the problems described above. The object according to the invention is achieved by the method according to the characteristic part of claim 1, which is characterized in that the particles to be produced are hydrophobic particles and the particles are guided onto the glass surface so that they at least partly dissolve and/or diffuse into the glass surface.

Preferred embodiments of the invention are disclosed in the dependent claims.

The object according to the invention is achieved by using nano-sized particles which are hydrophobic and which are brought onto the surface of glass or glazing so that they partly dissolve and/or diffuse inside the glass substrate so that a hydrophobic surface structure is formed on the glass.

By means of the method according to the invention, a hydrophobic glass surface may be produced on the glass surface during its production (float process) or during processing. The nanoparticles may be glass particles, preferably fluorine-alloyed quartz glass. In the method, no separate coating or film is formed onto the glass or glass surface as in prior art but the nanoparticles are allowed to partly dissolve and/or diffuse onto the surface of glass or glazing so that a hydrophobic surface structure is formed onto the glass or glazing. Furthermore, the method may be implemented at the normal air pressure. In addition, the temperature of glass or glazing is preferably at the cooling temperature of glass or above it, which enables efficient dissolution and/or diffusion of nanoparticles into glass. Below the glass cooling temperature, dissolution and/or diffusion into glass is inefficient for achieving the desired objects.

By means of the method according to the invention, a glass surface may be made hydrophobic so that particles brought onto the glass surface partly dissolve and/or diffuse into the surface of glass or glazing and form a hydrophobic surface structure for glass. Thus the particles adhere firmly to the glass and are not easily detached therefrom by wear and use. Thus in practice, the hydrophobicity of the glass surface lasts in use considerably longer than a hydrophobic coating produced by prior art techniques. This increases the life cycle of glass by several times.

### BRIEF DESCRIPTION OF THE FIGURES

The invention will now be described in greater detail by means of preferred embodiments with reference to the enclosed FIGURE, which illustrates a method of providing a hydrophobic glass surface according to the invention.

### DETAILED DESCRIPTION OF THE INVENTION

The method according to the invention comprises forming a hydrophobic surface for glass or glazing. The method comprises producing particles having an average aerodynamic particle size of less than 200 nm using a prior art method for producing such nanoparticles. The particles are further guided onto the glass surface so that they at least partly dissolve and/or diffuse into the glass surface. The particles to be guided onto the glass or glazing surface are hydrophobic particles, and preferably hydrophobic glass particles. For example, fluoro-alloyed quartz glass may be used for this purpose. Furthermore, the melting point of the nanoparticles to be guided onto the glass surface in the method is preferably higher than the melting point of glass or glazing, in which case the particles may be prevented from totally dissolving into glass.

The method according to the invention is applied or generally used in a production process, production or treatment of glass or glazing, which are described by examples below. Such production or treatment processes may include glass floating, glass hardening or formation of a glazed ceramic product or glazing for an object or firing. Thus the method may be applied in producing glass for cars, tractors, trains, airplanes or the like and/or in the production of glazed ceramic tiles or similar glazed products.

It is known that significant dissolution and/or diffusion into glass occurs when the glass temperature is below the glass cooling temperature. For this reason, the glass or glazing temperature is preferably risen above the cooling temperature in the method according to the invention.

In the following, the invention will be described in greater detail with reference to the enclosed drawing 1, which illustrates one way of producing a hydrophobic glass surface according to the invention. A glass substrate 10 moves in the direction indicated by the arrow. The glass may be, for example, flat glass produced by a float process, where the width of the glass web may be, for example, 4 metres and the web movement rate 20 m/min. The glass may also be a flat glass piece moving in a glass processing line in connection with the treatment of a windscreen. Fluorine-alloyed quartz glass particles 9 are produced by a flame spray 1 (the production line being provided with several parallel flame sprays). The size of the glass particles is at least 10 to 100 nanometres. The starting material of the glass particles is fluid tetraethyl-ortho-silicate (TEOS), which is fed by an infusion pump 6 to a burner 5 through a fluid channel 5 at a rate of 10 ml/min. Silicon-tetra-fluoride SiF₄ is fed from gas channel 2 to the flame spray for use as the starting material at a flow volume of 15 SML and hydrogen H₂ is fed from gas channel 4 to the flame spray at a flow volume of 30 SLM.

The flame spray is a liquid flame spray described in Finnish patent FI 98832. The end of the flame spray is provided with a nozzle 7, where the fluid starting material is sprayed by means of a gas in the burner. The drops generated by spraying travel into the flame 8 and upon reacting form nano-sized glass particles 9. In the exemplary case, the glass particles are hydrophobic fluorine-alloyed quartz particles. The glass particles are guided onto the glass surface 10, whose temperature is approximately 700° C. The glass particles form a highly hydrophobic and adhesive surface structure on the surface of the glass substrate, the particles 9 being at least partly dissolved and/or diffused into the surface structure.

In the following example, the formation of a hydrophobic surface onto glass is described according to the invention in connection with a production process of float glass. Float glass is produced by feeding a continuous flow of molten glass onto a molten tin bath. The molten glass spreads over the metal surface and produces a high-quality plate of glass that may be temperature-polished later. The glass contains no waves or distortions. Nowadays the float process is the standard method in the glass production and over 90% of all flat glass produced in the world is float glass. In this process, raw material is continuously added to the melting furnace, where the raw material temperature is risen above 1000° C. by gas burners. Then the mixture flows over a dam, in which case a continuous flow of molten glass flows onto the molten tin bath. The glass flow is pulled along the surface of molten tin by pull conveyors, which are arranged on the sides of the float area and convey the glass into a cooling furnace. The purpose of controlled cooling of glass (annealing) is to prevent internal tensions that may later cause the glass to break.

The production of a hydrophobic glass surface may take place at any stage between the dam of the float process and the inlet of the cooling furnace. In the cooling furnace and after it, the glass temperature is too low for efficient diffusion and/or dissolution of nanoparticles into glass. In the melting furnace, the glass temperature is too high and nanoparticles completely dissolve into glass. Thus the optimal point for achieving a hydrophobic surface is between the tin bath and the cooling furnace because in that case, it is not necessary to arrange the apparatus for forming a hydrophobic surface in the area of the tin bath.

According to the invention, the hydrophobic surface may also be formed in connection with glass hardening. In glass hardening, a formed glass object is re-heated to bring the object to a nearly soft state. After this, the glass object is, in strictly controlled conditions, cooled rapidly with cold air or alternatively by dipping it into oil or certain liquid chemicals. The hardening treatment makes the glass a lot harder than ordinary glass.

The formation of a hydrophobic glass surface according to the invention may also take place when the glass is re-heated in the hardening line or when glass travels from the re-heating furnace to a hardening chamber, i.e. a cooling chamber. After the glass has been cooled, its temperature is too low for efficient diffusion and/or dissolution of nanoparticles.

In addition to glass surfaces, the hydrophobic surface may be formed according to the invention onto glazed surfaces, such as glazed tiles or other glazed objects. In glazing, one or more glazing layers are formed onto the surface of an object, such as a ceramic object, the layer thickness being 75 to 500 microns, for instance. The glazing may be formed by several alternative methods. Glazing is formed onto an object or product, such as a ceramic product, to provide it with technical and aesthetic properties, such as water resistance, cleanability, polish, colour, surface patterning and chemical/and or mechanical durability. The glazing coating produced is substantially glassy, even though in several cases the glazing structure comprises crystal elements.

The production of a hydrophobic surface onto a glazed product may be combined with the firing of a ceramic product, for instance. Firing is one of the most important steps in the production process of tiles since most ceramic properties depend on the firing. These properties include mechanical strength, dimensional stability, chemical durability, cleanability, fire resistance, etc. In the firing stage, the main variables to be considered are the thermal cycle (temperature-time) and the atmosphere in the firing furnace, which need to be adjusted to each composition and production technique in accordance with the ceramic product to be produced. It is easiest to combine the formation of a hydrophobic surface according to the present invention with the cooling step of firing, provided that the temperature is above 400° C., below which the glazing becomes too viscous for efficient diffusion and/or dissolution of nanoparticles into glass.

In the method according to the invention, it is essential that the nanoparticies dissolve and/or diffuse partly or at least partly into a glass surface or glazed surface. It is further preferable that the nanoparticies have a high melting/softening temperature to prevent their complete dissolution into glass or glazing. Silicon particles alloyed on their surfaces to prevent formation of OH groups on their surface are an excellent material for the purposes of the invention. Silicon particles may be alloyed by fluorine, for instance.

The invention may also comprise solutions differing from what was described above. Thus the material of the particles may be different and the nanoparticles may be produced otherwise, for example by means of a steam route, liquid route, solid route or a combination thereof, which are described for example in Materials Science and Engineering, R 45, 2004, Tjong, S. C. & Chen, H., Nanocrystalline materials and coatings, pp. 1-88.

1. A method of forming a hydrophobic surface for glass or glazing, the method comprising producing particles having an average aerodynamic particle size of less than 200 nm and guiding the particles further onto the glass surface, wherein
the particles to be produced are hydrophobic particles; and
the particles are guided onto the glass surface so that they partly dissolve and/or diffuse into the glass surface.

2. A method according to claim 1, wherein the nanoparticles are hydrophobic glass particles.

3. A method according to claim 1, wherein the nanopartioles consist of fluorine-alloyed quartz glass.

4. A method according to claim 1, wherein the melting point of nanoparticles is higher than the melting point of glass.

5. A method according to claim 1, wherein the method is applied in a production process, production or treatment of glass or glazing.

6. A method according to claim 5, wherein the method is applied in the production and/or processing of flat glass.

7. A method according to claim 6, wherein the method is applied in a glass floating process.

8. A method according to claim 5, wherein the method is applied in glass hardening.

9. A method according to claim 1, wherein the method is applied in producing glass for cars, tractors, trains, air-planes or the like.

10. A method according to claim 5, wherein the method is applied in formation or firing of a glazed ceramic product or object.

11. A method according to claim 5, wherein the method is used in producing a glazed tile or a similar glazed product.

12. A method according to claim 1, wherein the method is carried out at the normal air pressure.

13. A method according to claim 1, wherein the method is carried out when the glass temperature is above the cooling temperature of glass.

14. A method according to claim 1, wherein the nanoparticles and their guiding onto the glass surface are performed using a liquid flame spraying technique.

15. A method according to claim 1, wherein the nanoparticles are produced by a laser ablation technique.

16. A method according to claim 1, wherein the nanoparticles are produced by using a steam route, liquid route, solid route or a combination thereof.
